(19) United States
(12) Patent Application Publication
(10) Pub. No.: US 2020/0134180 A1
(43) Pub. Date: Apr. 30, 2020

(54) ENHANCED PROTECTIONS AGAINST ADVERSARIAL MACHINE LEARNING THREATS UTILIZING CRYPTOGRAPHY AND HARDWARE ASSISTED MONITORING IN ACCELERATORS

(71) Applicant: Intel Corporation, Santa Clara, CA (US)

(72) Inventors: Reshma Lal, Portland, OR (US); Luis S. Kida, Beaverton, OR (US); Pradeep M. Pappachan, Tualatin, OR (US)

(73) Assignee: Intel Corporation, Santa Clara, CA (US)

(21) Appl. No.: 16/725,474

(22) Filed: Dec. 23, 2019

(51) Int. Cl. G06F 21/56; H04L 9/14; H04L 9/08; G06N 20/00; G06N 5/04

(52) U.S. Cl. CPC G06F 21/566; H04L 9/14; G06F 2221/033; G06N 20/00; G06N 5/04; H04L 9/085

(57) ABSTRACT

Embodiments are directed to enhanced protections against adversarial machine learning threats utilizing cryptography and hardware assisted monitoring in hardware accelerators. An embodiment of a system includes one or more processors including a trusted execution environment (TEE), the TEE including a machine learning (ML) service enclave, the ML service enclave including monitoring software; a hardware accelerator including a cryptographic engine and metering hardware, the hardware accelerator to perform processing related to an ML model and the metering hardware to generate statistics regarding data transfers; and an interface with one or more data owners, the ML service enclave to provide access control and data protection for ML data related to the ML model, including establishing secret encryption keys with the data owners and the hardware accelerator; and the monitoring software to analyze the statistics to identify suspicious patterns in the data transfers.

### TECHNICAL FIELD

Embodiments described herein generally relate to the field of electronic devices and, more particularly, enhanced protections against adversarial machine learning threats utilizing cryptography and hardware assisted monitoring in hardware accelerators.

### BACKGROUND

AI (Artificial Intelligence) and ML (Machine Learning) training and inferencing are vulnerable to multiple different adversarial machine learning threats. These threats include attacks to model extraction or reverse engineering the model, poisoning of a model during training, inversion attack to extract training data, and evasion attack in which the attacker modifies the input to evade detection.

Adversarial ML attacks are possible during both training and inferencing. As AI and ML processing continue to move into new technical fields, conventional reliance on algorithmic methods to detect and thwart adversarial attacks is insufficient, and thus additional security measures are required

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of a system to provide enhanced security against adversarial attacks according to some embodiments;

FIG. 2 is an illustration of elements to provide enhanced protection against adversarial attacks according to some embodiments;

FIG. 3 is an illustration of a system architecture to provide enhanced protection against adversarial attacks according to some embodiments;

FIG. 4 is an illustration of a system architecture to provide enhanced protection against adversarial attacks according to some embodiments;

FIG. 5 is a flowchart to illustrate a process for protection against adversarial attacks according to some embodiments; and

FIG. 6 is a schematic diagram of an illustrative electronic computing device to enable enhanced protection against adversarial attacks according to some embodiments.

### DETAILED DESCRIPTION

Embodiments described herein are directed to enhanced protections against adversarial machine learning threats via cryptography and hardware assisted monitoring in accelerator.

Adversarial Machine Learning is a rapidly emerging class of threats against ML models or training data during training and inferencing. Examples of such threats include:

Model Extraction Attack:

An attacker attempts to extract or reverse engineer a trained model by inputting a large amount of data for inferencing and then analyze the inference results.

Model Poisoning Attack:

An attacker purposely feeds incorrect input data during training to maliciously alter trained models. For example, an attacker may submit diagnostic image of a sick person and label it as not sick which would cause to model to be trained incorrectly for diagnosis operation.

Model Inversion Attack:

An attacker attempts to recover training input data used to train a model by looking at statistics accompanying the inference results, such as confidence level. Confidence level of 100% may indicate parity with the input data used for training.

Evasion Attack:

An attacker modifies the input data to avoid detection of an attack.

In some embodiments, a system or process provides enhanced protection from adversarial machine learning attacks by combining the use of trusted execution environments (TEEs), secure hardware accelerators, and hardware assisted monitoring. A TEE may include, but is not limited to, Intel® Software Guard Extensions (SGX).

Preventing AML attacks should not depend solely on the strength and resilience of algorithms because it is very costly and difficult, if not impossible, to build and verify an algorithm as being robust against all possible attacks. While researchers are devising mechanisms to make an algorithms robust against known attacks, attackers are devising new methods of exploiting weaknesses in the algorithms. In some embodiments, by using cryptographic methods combined with HW assisted monitoring, a system or process is capable of preventing certain adversarial attacks and increasing the difficulty of the mounting of certain other attacks.

For example, by blocking visibility of inference inputs and inference results, a system or process can prevent model extraction attacks. By implementing cryptographic methods for detecting data modification, the system or process can prevent perturbation of input by a malicious entity. Further, the use of hardware statistics to enable software to detect suspicious patterns make it more difficult for an attacker to succeed in an attack.

As used herein, “hardware accelerator” refers to a hardware device structured to provide for efficient processing. In particular, a hardware accelerator may be utilized to provide for offloading of certain processing tasks from a central processing unit (CPU) or other general processor, wherein the hardware accelerator may be intended to provide more efficient processing of the processing tasks than software run on the CPU or other processor. A hardware accelerator may include, but is not limited to, a graphics processing unit (GPU), neural processing unit, AI (Artificial Intelligence) processor, field programmable gate array (FPGA), or application-specific integrated circuit (ASIC).

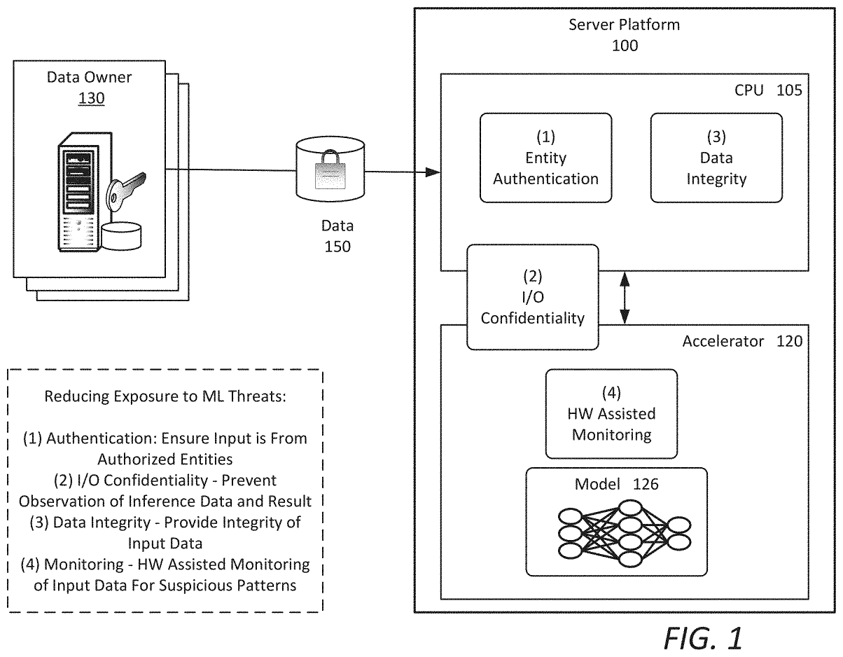

FIG. 1 is an illustration of a system to provide enhanced security against adversarial attacks according to some embodiments. As illustrated in FIG. 1, a server platform 100 includes one or more processors such as a central processing unit (CPU) 105, wherein the server platform 100 provides for processing of machine learning (ML) data. The ML processing may include at least some portion of the processing to be performed on a hardware accelerator 120, which is shown as including an ML model 126 for training or inference. The data 150 for processing may be sent by one or more data owners 130.

A conventional system or process may implement algorithmic methods to detect and thwart adversarial attacks on the ML processing performed by the server platform, but this is insufficient to provide adequate protection from sophisticated adversarial attacks.

In some embodiments, a system or process is to provide enhanced protection against adversarial attacks by:

(1) Entity Authentication: Ensuring that input data being received is from authorized entities, thereby reducing the risk of model poisoning attacks during training. For example, in a model poisoning attack an attacker mixes bad inputs, such as objects labeled incorrectly, with good inputs intermittently. For training without labels, where the training may be using statistical data, the attacker can insert arbitrary input. The authentication of an input source, such as the data 150 provided by data owner 130, may be implemented by the system or process to address this type of threat.

(2) I/O Confidentiality: Providing confidentiality of input and output to prevent observation of inference data and inference result, which reduces risk of reverse engineering of an ML model by an attacker.

(3) Data Integrity: Ensuring integrity of input data to prevent an attacker from creating perturbations that can be utilized in evasion attacks.

(4) HW Assisted Monitoring: Providing hardware assisted monitoring of input data for suspicious patterns. Typically hardware is used in a system to generate statistics about the data traffic for resource and bandwidth allocation. In some embodiments, additional hardware generated statistics, such as frequency of data transfer per user, size of the data transfer per user, etc., are generated to allow software to monitor for suspicious patterns. If the generated statistics indicate possible suspicious pattern, the software can perform further analysis of the data to identify potentially malicious patterns within the data itself. The patterns that are considered to be suspicious may depend on the nature of the ML model. For example, for a Natural Language Processing system for speech recognition, there may be certain data sizes expected, but, if the hardware detects a large series of data from the same user that is, for example, one character wide, this might be considered an abnormal pattern warranting further analysis by the software. In some embodiments, the hardware monitoring is programmable by software to customize the monitoring for specific needs of a given model,

In some embodiments, usage of a hardware accelerator can be metered through use of metering hardware to manage the resource or bandwidth allocation. This mechanism may be utilized to deter the extraction by making it much harder to submit massive amount of inference data. Depending on the data model, certain patterns may be indicative of attacks.

It is noted that, as further described below, enhanced protections can still be implemented in scenarios in which entity authentication is not possible, such as where input might be coming from crowd sourcing and thus the source of input cannot be trusted. In usages such as federated machine learning for health care systems where input is coming from hospitals that are trusted sources, a protection mechanism built in a system is capable of preventing many attacks and deterring others by making the attacks more difficult to mount. Hardware assisted monitoring still provides enhanced security when the source of input cannot be authenticated. While a white list of authorized users or a trusted channel between input source and CPU may not implemented, data patterns can be monitored for anomalous input requiring further analysis, a TEE can be provided for policy enforcement and advance analysis, and a trusted channel between the CPU and TEE can be implemented such that a hardware monitoring stack can be sampled with integrity.

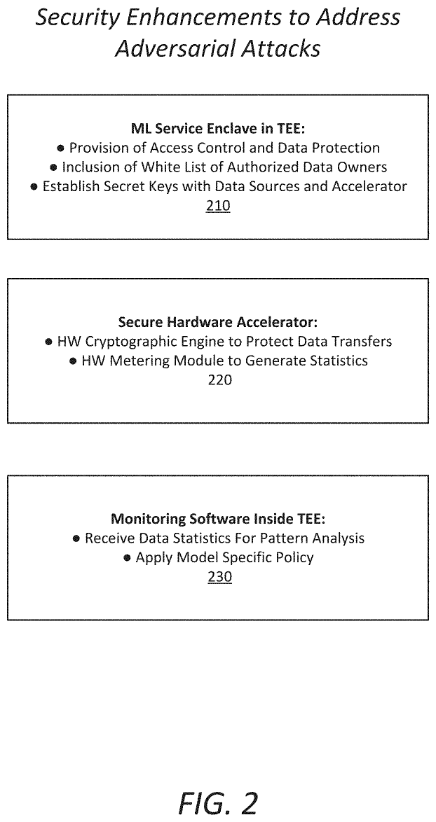

FIG. 2 is an illustration of elements to provide enhanced protection against adversarial attacks according to some embodiments. In some embodiments, an apparatus or system includes one or more of the following:

(1) ML Service Enclave in TEE 210:

In some embodiments, a system includes an ML Service Enclave (MLSE) running on a host CPU to which a hardware accelerator is attached. The ML Service Enclave may be owned by the platform owner or the model owner, and is to run inside a trusted execution environment (TEE) like SGX, capable of attesting itself to a remote entity and to the accelerator. The main functions of the ML Service Enclave are the following:

(a) The ML Service Enclave is responsible for access control and data protection. In some embodiments, the ML Service Enclave contains a dynamically provisioned whitelist of authorized data owners who are allowed to submit data for training or inferencing. The white list may be created by the model owner, and each model owner who is assigned the accelerator may provision its own white list. The ML Service Enclave may also be provisioned with a policy that describes data patterns and parameters such as frequency of input submission, size of input data, etc., that may indicate potentially suspicious data patterns. In some embodiments, the MLSE is to authenticate each of the connected data sources and establish shared secret keys with each data source. Thus, the ML Service Enclave is to serves as a gate for who is or is not allowed to submit data for to a model running on the accelerator.

(b) MLSE also establishes shared secret key with the accelerator after successful attestation of the accelerator. If the data is pre- or post-processed on the CPU, the ML enclave may further perform encryption/decryption of data to protect during transfers to/from the accelerator.

(2) Secure Hardware Accelerator 220:

In some embodiments, a secure hardware accelerator includes a hardware cryptographic engine in that is to protect all data transfers to or from the host system. The accelerator further includes a hardware metering circuitry or module that generates statistics to capture characterization of data transfers such as rate of input per user. In some embodiments, hardware metering is programmable by trusted software to select which statistics to generate because the statistics that are needed may be model specific.

(3) Monitoring Software Inside TEE 230:

In some embodiments, monitoring software is to run inside a TEE. The monitoring software is to receive statistics from the hardware accelerator for analysis of patterns. In some embodiments, the monitoring software is to apply a policy that is model specific. In implementation, each model owner is not required to write their own detector. A generic software may be applied, wherein the model owner may specify a policy for software monitor, and thus the model owner is not burdened with providing data other than the policy to be implemented and enforced.

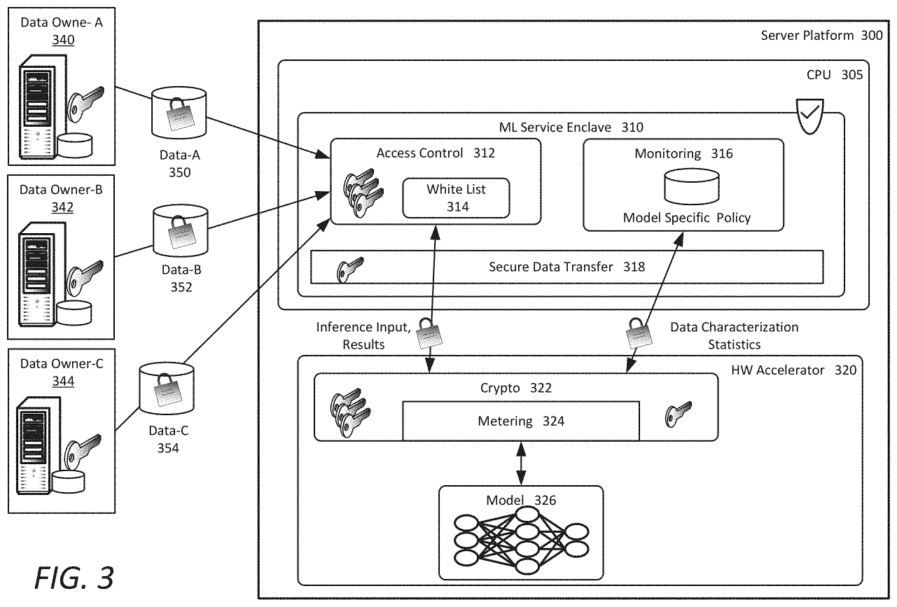

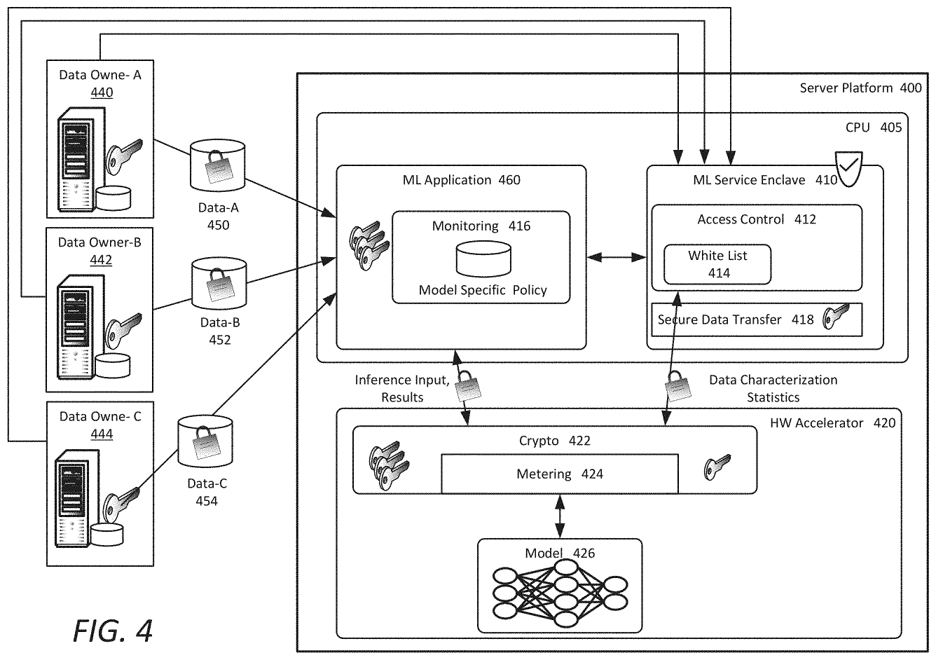

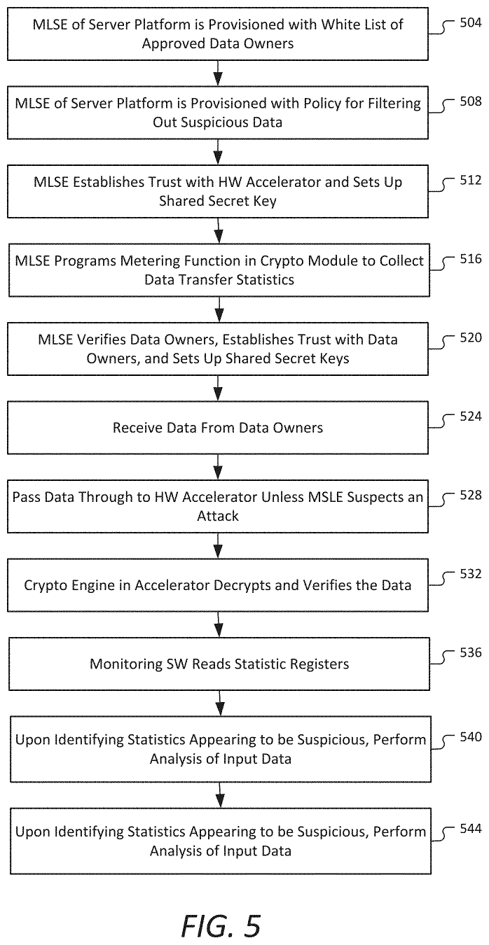

In some embodiments, the of elements to provide enhanced protection against enhanced security against adversarial attacks may be implemented as illustrated in a system architecture as illustrated in FIGS. 3 and 4, or in a process as illustrated in FIG. 5.

FIG. 3 is an illustration of a system architecture to provide enhanced protection against adversarial attacks according to some embodiments. As illustrated in FIG. 3, a server platform 300, which may be referred to as a host system, includes one or more processors such as the illustrated CPU 305. The server platform 300 further includes a hardware accelerator 320 that may provide for processing of data, including inference or training for an ML model 326 (or multiple ML models), the ML model 326 having an owner who provides such model. The server platform is further to include an interface to receive data from one or more data owners, such as Data Owner-A 340 to provide Data-A 350; Data Owner-B 342 to provide Data-B 352; and Data Owner-C 344 to provide Data-C 354.

The CPU includes a TEE, such as SGX or other technology, and further includes an machine learning service enclave (MLSE) 310 within the TEE to provide for support including access control 312 to control the access for the machine learning model 326, including inference inputs and results. The access control 312 may include a white list 314 identifying data owners who are authorized to submit ML data for inference or training, wherein the whitelist may be received from the owner of ML model 326. The ML service enclave may further include monitoring software 316 to monitor data received from the data owners 340 and identify possible suspicious patterns. The monitoring software 316 may operate according to a model specific policy, wherein the policy may be identified by the owner of the ML model 326. The MLSE 310 further provides secure data transfer 318, wherein the secure data transfer includes establishing trust with the HW accelerator 320 and setting up a shared secret key with the HW accelerator 320, and establishing trust with the data owners 340-344 and setting up shared secret keys with the data owners.

In some embodiments, the HW accelerator 320 includes a cryptographic engine (crypto) 322, and metering hardware 324 to generate data transfer statistics per user, such as rate of input, size of input, etc., to allow monitoring of how each data user is operating in relation to the ML model 326.

FIG. 4 is an illustration of a system architecture to provide enhanced protection against adversarial attacks according to some embodiments. As illustrated in FIG. 4, a server platform 400 includes one or more processors such as the illustrated CPU 405. The server platform 400 further includes a hardware (HW) accelerator 420 that may provide for processing of data includes machine learning inference and training, including inference or training for an ML model 426, the ML model 426 having an owner who has provide such model. The server platform is further to include an interface to receive data from one or more data owners, such as Data Owner-A 440 to provide Data-A 450; Data Owner-B 442 to provide Data-B 452; and Data Owner-C 444 to provide Data-C 454.

The CPU 405 includes a TEE, such as SGX or other technology, and further includes an MLSE 410 within the TEE to provide for support including access control 412 to control the access for the machine learning model 426, including inference inputs and results. The access control 412 may include a white list 414 identifying data owners who are authorized to submit ML data for inference or training, wherein the whitelist may be received from the owner of ML model 426.

As illustrated in FIG. 4, in an alternative implementation, a local ML application 460 is to run on the server platform where pre- and post-processing steps occur. In this example, data being received from a remote entity does not pass through as some of the workload is to be run on the CPU 405 as well as the HW accelerator 420. In this example, the monitoring software 416 is embedded in the ML application 460. In this embodiment, the MLSE 410 remains responsible for verifying the data owners and provisioning keys, and includes secure data transfer 418. The MLSE 410 also provides these keys to the ML application 460. The MLSE 410 is also to provision the monitoring policy in the HW accelerator 420. After the initial setup, the MLSE 410 is not within the data path for the ML model 426. The monitoring SW 416 embedded in application 460 checks the statistics periodically to determine if the monitoring software 416 needs to scrutinize data from any of the users. If statistics from any user look suspicious, then the monitoring software 416 examines the data to perform advanced analysis to detect anomalous pattern that could indicate a potential attack.

In some embodiments, the HW accelerator 420 again includes a cryptographic engine (crypto) 422, and metering hardware 424 to generate data transfer statistics per user, such as rate of input, size of input, etc., to allow monitoring of how each data user is operating in relation to the ML model 426.

FIG. 5 is a flowchart to illustrate a process for protection against adversarial attacks according to some embodiments. In a system, such as illustrated in FIG. 3 or FIG. 4, to provide ML processing, processes are provided enhance protections agailnst ML adversarial attacks.

In some embodiments, an ML service enclave, such as MLSE 310 illustrated in FIG. 3 or MLSE 410 illustrated in FIG. 4, within a TEE of a processor in a server platform is provisioned by a model owner with a white list of data owners who are authorized to submit ML data for training or inference 504. The model owner may also provision a policy for filtering out suspicious data based on certain patterns 508. The MLSE is to establishes trust with a HW accelerator, such as HW accelerator 320 illustrated in FIG. 3 or HW accelerator 420 illustrated in FIG. 4, and sets up shared secret key with the HW accelerator 512.

If a monitoring policy is provisioned into the MLSE, then the MLSE is to program a metering function in the server platforms cryptographic engine to collect data transfer statistics per user, such as rate of input, size of input, etc. 516.

Upon the MLSE verifying identity of data owners and checking their authorizations against the white list, the MLSE establishes trust with the data owners and sets up shared secret keys with the data owners 520. The MLSE may also send the data keys wrapped with key established with the HW accelerator to the cryptographic engine in the server, which can support multiple keys.

The server platform then is to receive data submitted by data owners, the data being transferred with cryptographic protection using the shared secret keys 524. The data may normally be passed through to the hardware accelerator, where the data is decrypted and verified prior to the data being consumed, unless the MLSE suspects an attack and further examines the data 528

The crypto engine in the accelerator decrypts and verifies the input data 532. If the metering function has been programmed, this function generates statistics based on data transfers and updates the statistics in, for example, internal statistic registers or other similar storage.

The monitoring SW is to read the statistic registers 536, which may occur periodically. The reading of the statistics is to be performed securely using the established key to protect the integrity of statistics being read. Upon identifying any statistics that appear to be suspicious, the monitoring SW is to commence performing more sophisticated analysis of input data from any user whose statistics appeared to be suspicious 540. The monitoring SW may examine the data and compare this against the model specific policy that is specified. In some embodiments, the monitoring SW is to raise an alert upon identifying a possible attack 544. In some embodiments, a reporting mechanism may be built into the system to report the alert to the model owner to take further action.

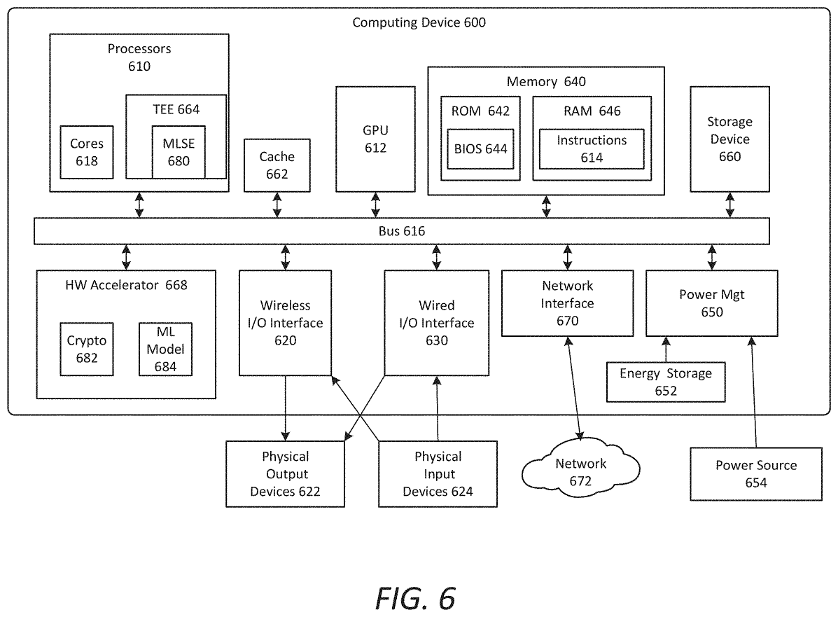

FIG. 6 is a schematic diagram of an illustrative electronic computing device to enable enhanced protection against adversarial attacks according to some embodiments. In some embodiments, the computing device 600 includes one or more processors 610 including one or more processors cores 618 and a TEE 664, the TEE including a machine learning service enclave (MLSE) 680. In some embodiments, the computing device 600 includes a hardware accelerator 668, the hardware accelerator including a cryptographic engine 682 and a machine learning model 684. In some embodiments, the computing device is to provide enhanced protections against ML adversarial attacks, as provided in FIGS. 1-5.

The computing device 600 may additionally include one or more of the following: cache 662, a graphical processing unit (GPU) 612 (which may be the hardware accelerator in some implementations), a wireless input/output (I/O) interface 620, a wired I/O interface 630, memory circuitry 640, power management circuitry 650, non-transitory storage device 660, and a network interface 670 for connection to a network 672. The following discussion provides a brief, general description of the components forming the illustrative computing device 600. Example, non-limiting computing devices 600 may include a desktop computing device, blade server device, workstation, or similar device or system.

In embodiments, the processor cores 618 are capable of executing machine-readable instruction sets 614, reading data and/or instruction sets 614 from one or more storage devices 660 and writing data to the one or more storage devices 660. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 618 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 600 includes a bus or similar communications link 616 that communicably couples and facilitates the exchange of information and/or data between various system components including the processor cores 618, the cache 662, the graphics processor circuitry 612, one or more wireless I/O interfaces 620, one or more wired I/O interfaces 630, one or more storage devices 660, and/or one or more network interfaces 670. The computing device 600 may be referred to in the singular herein, but this is not intended to limit the embodiments to a single computing device 600, since in certain embodiments, there may be more than one computing device 600 that incorporates, includes, or contains any number of communicably coupled, collocated, or remote networked circuits or devices.

The processor cores 618 may include any number, type, or combination of currently available or future developed devices capable of executing machine-readable instruction sets.

The processor cores 618 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 6 are of conventional design. Consequently, such blocks need not be described in further detail herein, as they will be understood by those skilled in the relevant art. The bus 616 that interconnects at least some of the components of the computing device 600 may employ any currently available or future developed serial or parallel bus structures or architectures.

The system memory 640 may include read-only memory (“ROM”) 642 and random access memory (“RAM”) 646. A portion of the ROM 642 may be used to store or otherwise retain a basic input/output system (“BIOS”) 644. The BIOS 644 provides basic functionality to the computing device 600, for example by causing the processor cores 618 to load and/or execute one or more machine-readable instruction sets 614. In embodiments, at least some of the one or more machine-readable instruction sets 614 cause at least a portion of the processor cores 618 to provide, create, produce, transition, and/or function as a dedicated, specific, and particular machine, for example a word processing machine, a digital image acquisition machine, a media playing machine, a gaming system, a communications device, a smartphone, or similar.

The computing device 600 may include at least one wireless input/output (I/O) interface 620. The at least one wireless I/O interface 620 may be communicably coupled to one or more physical output devices 622 (tactile devices, video displays, audio output devices, hardcopy output devices, etc.). The at least one wireless I/O interface 620 may communicably couple to one or more physical input devices 624 (pointing devices, touchscreens, keyboards, tactile devices, etc.). The at least one wireless I/O interface 620 may include any currently available or future developed wireless I/O interface. Example wireless I/O interfaces include, but are not limited to: BLUETOOTH®, near field communication (NFC), and similar.

The computing device 600 may include one or more wired input/output (I/O) interfaces 630. The at least one wired I/O interface 630 may be communicably coupled to one or more physical output devices 622 (tactile devices, video displays, audio output devices, hardcopy output devices, etc.). The at least one wired I/O interface 630 may be communicably coupled to one or more physical input devices 624 (pointing devices, touchscreens, keyboards, tactile devices, etc.). The wired I/O interface 630 may include any currently available or future developed I/O interface. Example wired I/O interfaces include, but are not limited to: universal serial bus (USB), IEEE 1394 (“FireWire”), and similar.

The computing device 600 may include one or more communicably coupled, non-transitory, data storage devices 660. The data storage devices 660 may include one or more hard disk drives (HDDs) and/or one or more solid-state storage devices (SSDs). The one or more data storage devices 660 may include any current or future developed storage appliances, network storage devices, and/or systems. Non-limiting examples of such data storage devices 660 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 660 may include one or more removable storage devices, such as one or more flash drives, flash memories, flash storage units, or similar appliances or devices capable of communicable coupling to and decoupling from the computing device 600.

The one or more data storage devices 660 may include interfaces or controllers (not shown) communicatively coupling the respective storage device or system to the bus 616. The one or more data storage devices 660 may store, retain, or otherwise contain machine-readable instruction sets, data structures, program modules, data stores, databases, logical structures, and/or other data useful to the processor cores 618 and/or graphics processor circuitry 612 and/or one or more applications executed on or by the processor cores 618 and/or graphics processor circuitry 612. In some instances, one or more data storage devices 660 may be communicably coupled to the processor cores 618, for example via the bus 616 or via one or more wired communications interfaces 630 (e.g., Universal Serial Bus or USB); one or more wireless communications interfaces 620 (e.g., Bluetooth®, Near Field Communication or NFC); and/or one or more network interfaces 670 (IEEE 802.3 or Ethernet, IEEE 802.11, or Wi-Fi®, etc.).

Processor-readable instruction sets 614 and other programs, applications, logic sets, and/or modules may be stored in whole or in part in the system memory 640. Such instruction sets 614 may be transferred, in whole or in part, from the one or more data storage devices 660. The instruction sets 614 may be loaded, stored, or otherwise retained in system memory 640, in whole or in part, during execution by the processor cores 618 and/or graphics processor circuitry 612.

The computing device 600 may include power management circuitry 650 that controls one or more operational aspects of the energy storage device 652. In embodiments, the energy storage device 652 may include one or more primary (i.e., non-rechargeable) or secondary (i.e., rechargeable) batteries or similar energy storage devices. In embodiments, the energy storage device 652 may include one or more supercapacitors or ultracapacitors. In embodiments, the power management circuitry 650 may alter, adjust, or control the flow of energy from an external power source 654 to the energy storage device 652 and/or to the computing device 600. The power source 654 may include, but is not limited to, a solar power system, a commercial electric grid, a portable generator, an external energy storage device, or any combination thereof.

For convenience, the processor cores 618, the graphics processor circuitry 612, the wireless I/O interface 620, the wired I/O interface 630, the storage device 660, and the network interface 670 are illustrated as communicatively coupled to each other via the bus 616, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In another example, one or more of the above-described components may be integrated into the processor cores 618 and/or the graphics processor circuitry 612. In some embodiments, all or a portion of the bus 616 may be omitted and the components are coupled directly to each other using suitable wired or wireless connections.

In some embodiments, a system includes one or more processors including a trusted execution environment (TEE), the TEE including a machine learning (ML) service enclave, the ML service enclave including monitoring software; a hardware accelerator including a cryptographic engine and metering hardware, the hardware accelerator to perform processing related to an ML model and metering hardware to generate statistics regarding data transfers; and an interface with one or more data owners; wherein the ML service enclave is to provide access control and data protection for ML data related to the ML model, including establishing secret encryption keys with the data owners and the hardware accelerator; and wherein the monitoring software is to analyze the statistics to identify suspicious patterns in the data transfers.

In some embodiments, the access control is provided within the ML service enclave.

In some embodiments, the one or more processors are to run a ML application, the access control being embedded in the ML application.

In some embodiments, the access control includes a white list, the white list identifying one or more data owners who are authorized to submit ML data for the ML model.

In some embodiments, the monitoring software includes a policy that is associated with the ML model.

In some embodiments, the monitoring software is to perform analysis of ML data relating to one or more data owners upon identifying a suspicious pattern in the data transfers.

In some embodiments, the metering hardware is programmable to select one or more statistics to be generated.

In some embodiments, the one or more processors include a central processing unit (CPU).

In some embodiments, one or more non-transitory computer-readable storage mediums having stored thereon executable computer program instructions that, when executed by one or more processors, cause the one or more processors to perform operations including establishing trust between a host system and a hardware accelerator and establishing a shared secret key with the hardware accelerator, the system including a trusted execution environment (TEE) having a machine learning (ML) service enclave, and the hardware accelerator including a cryptographic engine and metering hardware, the ML service enclave to perform processing with an ML model; establishing trust between the host system and one or more data owners and establishing a shared secret key with each of the one or more data owners; receiving encrypted ML data from the one or more data owners and performing access control for the received ML data; decrypting the encrypted ML data by the cryptographic engine and generating statistics for the ML data by the metering hardware; and performing analysis of the ML data from the one or more data owners by monitoring software to identify suspicious patterns in the ML data.

In some embodiments, the access control is provided within the ML service enclave.

In some embodiments, the instructions include instructions for running an ML application by the host system, the access control being embedded in the ML application.

In some embodiments, performing access control includes utilizing a white list, the white list identifying one or more data owners who are authorized to submit ML data for the ML model.

In some embodiments, the monitoring software includes a policy that is associated with the ML model.

In some embodiments, the instructions include instructions for performing, by the monitoring software, analysis of ML data relating to one or more data owners upon identifying a suspicious pattern in the data transfers.

In some embodiments, the instructions include instructions for programming the metering hardware to select one or more statistics to be generated.

In some embodiments, a method includes establishing trust between a host system and a hardware accelerator and establishing a shared secret key with the hardware accelerator, the system including a trusted execution environment (TEE) having a machine learning (ML) service enclave, and the hardware accelerator including a cryptographic engine and metering hardware, the ML service enclave to perform processing with an ML model; establishing trust between the host system and one or more data owners and establishing a shared secret key with each of the one or more data owners; receiving encrypted ML data from the one or more data owners and performing access control for the received ML data; decrypting the encrypted ML data by the cryptographic engine and generating statistics for the ML data by the metering hardware; performing analysis of the ML data from the one or more data owners by monitoring software to identify suspicious patterns in the ML data; and upon identifying a suspicious pattern in the data transfers, performing, by the monitoring software, analysis of ML data relating to one or more data owners.

In some embodiments, performing access control includes utilizing a white list, the white list identifying one or more data owners who are authorized to submit ML data for the ML model.

In some embodiments, the monitoring software includes a policy that is associated with the ML model.

In some embodiments, the method further includes programming the metering hardware to select one or more statistics to be generated.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

What is claimed is:

1. A system comprising:
one or more processors including a trusted execution environment (TEE), the TEE including a machine learning (ML) service enclave, the ML service enclave including monitoring software;
a hardware accelerator including a cryptographic engine and metering hardware, the hardware accelerator to perform processing related to an ML model and metering hardware to generate statistics regarding data transfers; and
an interface with one or more data owners;
wherein the ML service enclave is to provide access control and data protection for ML data related to the ML model, including establishing secret encryption keys with the data owners and the hardware accelerator; and
wherein the monitoring software is to analyze the statistics to identify suspicious patterns in the data transfers.

2. The system of claim 1, wherein the access control is provided within the ML service enclave.

3. The system of claim 1, wherein the one or more processors are to run a ML application, the access control being embedded in the ML application.

4. The system of claim 1, wherein the access control includes a white list, the white list identifying one or more data owners who are authorized to submit ML data for the ML model.

5. The system of claim 1, wherein the monitoring software includes a policy that is associated with the ML model.

6. The system of claim 1, wherein the monitoring software is to perform analysis of ML data relating to one or more data owners upon identifying a suspicious pattern in the data transfers.

7. The system of claim 1, wherein the metering hardware is programmable to select one or more statistics to be generated.

8. The system of claim 1, wherein the one or more processors include a central processing unit (CPU).

9. One or more non-transitory computer-readable storage mediums having stored thereon executable computer program instructions that, when executed by one or more processors, cause the one or more processors to perform operations comprising:
establishing trust between a host system and a hardware accelerator and establishing a shared secret key with the hardware accelerator, the system including a trusted execution environment (TEE) having a machine learning (ML) service enclave, and the hardware accelerator including a cryptographic engine and metering hardware, the ML service enclave to perform processing with an ML model;
establishing trust between the host system and one or more data owners and establishing a shared secret key with each of the one or more data owners;
receiving encrypted ML data from the one or more data owners and performing access control for the received ML data;
decrypting the encrypted ML data by the cryptographic engine and generating statistics for the ML data by the metering hardware; and
performing analysis of the ML data from the one or more data owners by monitoring software to identify suspicious patterns in the ML data.

10. The one or more mediums of claim 9, wherein the access control is provided within the ML service enclave.

11. The one or more mediums of claim 9, wherein the instructions further include instructions for:
running an ML application by the host system, the access control being embedded in the ML application.

12. The one or more mediums of claim 9, wherein performing access control includes utilizing a white list, the white list identifying one or more data owners who are authorized to submit ML data for the ML model.

13. The one or more mediums of claim 9, wherein the monitoring software includes a policy that is associated with the ML model.

14. The one or more mediums of claim 9, wherein the instructions further include instructions for:
performing, by the monitoring software, analysis of ML data relating to one or more data owners upon identifying a suspicious pattern in the data transfers.

15. The one or more mediums of claim 9, wherein the instructions further include instructions for:
programming the metering hardware to select one or more statistics to be generated.

16. A method comprising:
establishing trust between a host system and a hardware accelerator and establishing a shared secret key with the hardware accelerator, the system including a trusted execution environment (TEE) having a machine learning (ML) service enclave, and the hardware accelerator including a cryptographic engine and metering hardware, the ML service enclave to perform processing with an ML model;
establishing trust between the host system and one or more data owners and establishing a shared secret key with each of the one or more data owners;
receiving encrypted ML data from the one or more data owners and performing access control for the received ML data;
decrypting the encrypted ML data by the cryptographic engine and generating statistics for the ML data by the metering hardware;
performing analysis of the ML data from the one or more data owners by monitoring software to identify suspicious patterns in the ML data; and
upon identifying a suspicious pattern in the data transfers, performing, by the monitoring software, analysis of ML data relating to one or more data owners.

17. The method of claim 16, wherein performing access control includes utilizing a white list, the white list identifying one or more data owners who are authorized to submit ML data for the ML model.

18. The method of claim 16, wherein the monitoring software includes a policy that is associated with the ML model.

19. The method of claim 16, further comprising programming the metering hardware to select one or more statistics to be generated.
